(19) United States
(12) Patent Application Publication
(10) Pub. No.: US 2017/0097054 A1
(43) Pub. Date: Apr. 6, 2017

(54) SELECTABLE ONE-WAY CLUTCH

(71) Applicant: TOYOTA JIDOSHA KABUSHIKI KAISHA, Toyota-shi (JP)

(72) Inventors: Mitsuaki TOMITA, Susono-shi (JP); Yuki KUROSAKI, Susono-shi (JP); Hiroyuki SHIOIRI, Yokohama-shi (JP); Hideaki KOMADA, Gotemba-shi (JP); Hiroyuki SHIBATA, Odawara-shi (JP)

(73) Assignee: TOYOTA JIDOSHA KABUSHIKI KAISHA, Toyota-shi (JP)

(21) Appl. No.: 15/273,216

(22) Filed: Sep. 22, 2016

(30) Foreign Application Priority Data
Oct. 6, 2015 (JP) 2015-198920

(51) Int. Cl. F16D 41/18

(52) U.S. Cl. CPC F16D 41/185

(57) ABSTRACT

A selectable one-way clutch includes: a fixed plate; an annular rotating plate that faces the fixed plate and rotates relative to the fixed plate; an engagement piece that is held by the fixed plate to protrude toward the rotating plate; an engagement concave portion formed on the rotating plate to be engaged with the engagement piece; and an annular selector plate placed between the fixed plate and the rotating plate and switches states of the engagement piece, the selectable one-way clutch selectively switching between an engagement state in which the engagement piece engages with the engagement concave portion and a release state in which rotations of the rotating plate in both directions are allowed. Further, notch portions are formed on an outer periphery portion of at least one of the selector plate and the rotating plate to have a shape passing through the plate in a thickness direction.

### CROSS-REFERENCE TO RELATED APPLICATION(S)

The present application claims priority to and incorporates by reference the entire contents of Japanese Patent Application No. 2015-198920 filed in Japan on Oct. 6, 2015.

### BACKGROUND OF THE INVENTION

1. Field of the Invention

The present disclosure relates to a selectable one-way clutch.

2. Description of the Related Art

A selectable one-way clutch that enables selective switching between a state (an engagement state) in which rotation directions of a rotating member are limited to one direction and a state (a release state) in which the rotating member is allowed to rotate in both directions is known as one type of one-way clutches.

Japanese Patent Application Laid-open No. 2008-082478 discloses a selectable one-way clutch including a fixed plate, a rotating plate that rotates relative to the fixed plate, a selector plate that switches between an engagement state and a release state, and engagement pieces that are attached to the fixed plate to engage with engagement concave portions of the rotating plate. The fixed plate and the rotating plate face each other and the selector plate is placed between the fixed plate and the rotating plate. The selector plate is configured to be rotated by an actuator and circumferentially reciprocates between a circumferential position (an engagement position) where the engagement pieces are capable of protruding toward the rotating plate and a circumferential position (a release position) where the engagement pieces are incapable of protruding toward the rotating plate. The selectable one-way clutch is configured to cause the engagement pieces of the fixed plate to protrude toward the rotating plate to achieve the engagement state when the selector plate is located at the engagement position and to retract the engagement pieces toward the fixed plate to achieve the release state when the selector plate is rotated from the engagement position to the release position.

### SUMMARY OF THE INVENTION

It is an object of the present disclosure to at least partially solve the problems in the conventional technology.

According to an aspect of the present disclosure, a selectable one-way clutch includes: a fixed plate; an annular rotating plate that is placed to face the fixed plate and rotates relative to the fixed plate; an engagement piece that is held by the fixed plate to protrude from the fixed plate toward the rotating plate; an engagement concave portion that is formed on the rotating plate to be engaged with the engagement piece protruding from the fixed plate toward the rotating plate; and an annular selector plate that is placed between the fixed plate and the rotating plate and switches between a state in which the engagement piece is protruded toward the rotating plate and a state in which the engagement piece is retracted toward the fixed plate not to be in contact with the rotating plate, the selectable one-way clutch being configured to selectively switch between an engagement state in which the engagement piece engages with the engagement concave portion to limit rotations of the rotating plate to one direction and a release state in which rotations of the rotating plate in both directions are allowed. Further, notch portions are formed on an outer periphery portion of at least one of the selector plate and the rotating plate to have a shape passing through the plate in a thickness direction.

According to another aspect of the present disclosure, a selectable one-way clutch comprising: a fixed plate; an annular rotating plate that is placed to face the fixed plate and rotates relative to the fixed plate; an engagement piece that is held by the fixed plate to protrude from the fixed plate toward the rotating plate; an engagement concave portion that is formed on the rotating plate to be engaged with the engagement piece protruding from the fixed plate toward the rotating plate; and an annular selector plate that is placed between the fixed plate and the rotating plate and switches between a state in which the engagement piece is protruded toward the rotating plate and a state in which the engagement piece is retracted toward the fixed plate not to be in contact with the rotating plate, the selectable one-way clutch being configured to selectively switch between an engagement state in which the engagement piece engages with the engagement concave portion to limit rotations of the rotating plate to one direction and a release state in which rotations of the rotating plate in both directions are allowed. Further, notch portions are formed on an outer periphery portion of at least one of the selector plate and the rotating plate, and the notch portions are concave portions obtained by lightening a facing surface between the selector plate and the rotating plate in a thickness direction.

### BRIEF DESCRIPTION OF THE DRAWINGS

The above and other objects, features, advantages and technical and industrial significance of this invention will be better understood by reading the following detailed description of presently preferred embodiments of the invention, when considered in connection with the accompanying drawings.

FIG. 1 is a skeleton diagram schematically illustrating an example of a vehicle on which a selectable one-way clutch is mounted;

FIG. 2 is a sectional view illustrating the selectable one-way clutch in a transaxle case;

FIG. 3A is an exploded view of the selectable one-way clutch;

FIG. 3B is a perspective view illustrating a facing surface of a notch plate with respect to a selector plate and that is not seen in FIG. 3A;

FIG. 4A is a collinear diagram illustrating a vehicle state in a case where a vehicle is driven forward in an OD mode;

FIG. 4B is a collinear diagram illustrating a vehicle state in a case where a vehicle is driven forward in a THS mode;

FIG. 4C is a collinear diagram illustrating a vehicle state at the time of an engine start;

FIG. 5A is schematic diagram illustrating an example of a modification in which notch portions of the selector plate are provided in the same phase as that of through-holes;

FIG. 5B is a schematic diagram illustrating a modification of the example illustrated in FIG. 5A; FIG. 5C is a schematic diagram illustrating another modification of the example illustrated in FIG. 5A;

FIG. 6A is a schematic diagram illustrating another example of the modification in which notch portions of the selector plate are provided in the same phase as that of through-holes;

FIG. 6B is a sectional view taken along line A-A of FIG. 6A;

FIG. 7A is a schematic diagram illustrating still another example of the modification in which notch portions of the selector plate are provided in the same phase as that of through-holes;

FIG. 7B is a sectional view taken along line B-B of FIG. 7A;

FIG. 8A is a schematic diagram illustrating a modification in which the notch portions of the selector plate illustrated in FIG. 3A are concave portions obtained by thinning the plate;

FIG. 8B is a sectional view taken along line C-C of FIG. 8A;

FIG. 9A is a schematic diagram illustrating a modification in which the notch portions of the selector plate illustrated in FIG. 5B are concave portions obtained by thinning the plate;

FIG. 9B is a sectional view taken along line D-D of FIG. 9A;

FIG. 10 is a skeleton diagram illustrating an example of a modification of a vehicle; and

FIG. 11 is a skeleton diagram illustrating another modification of a vehicle.

### DETAILED DESCRIPTION OF THE PREFERRED EMBODIMENTS

When a selectable one-way clutch is mounted on a vehicle, the selectable one-way clutch is placed with respect to a rotating member that is included in a transaxle. Therefore, oil that lubricates the transaxle is supplied into the selectable one-way clutch.

In the configuration described in Japanese Patent Application Laid-open No. 2008-082478, switching between the engagement position and the release position is achieved by rotating the selector plate with the actuator. However, in a state where the oil is supplied into the selectable one-way clutch, a rotation of the rotating plate relative to the selector plate causes a shear stress in the oil interposed between the rotating plate and the selector plate. The shear stress of the oil may circumferentially draw and rotate the selector plate. Accordingly, if the shear stress of the oil occurring at the time of a relative rotation becomes large, there is a risk that the selector plate at the release position is rotated together in an engagement direction due to the oil and that the selectable one-way clutch performs erroneous engagement. Exemplary embodiments of a selectable one-way clutch according to the present disclosure will be explained below in detail with reference to the accompanying drawings.

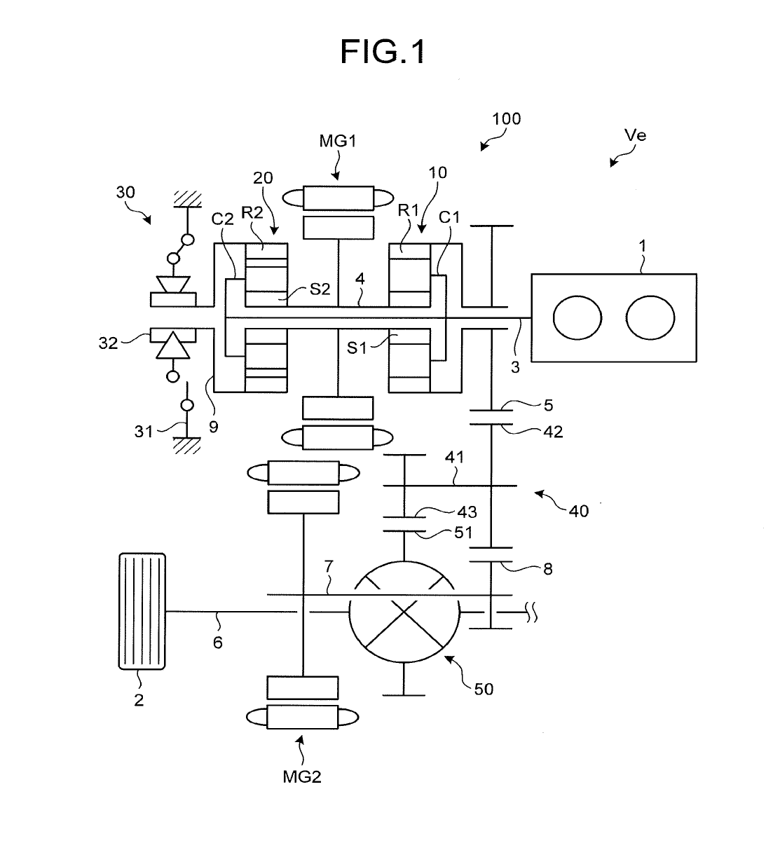

FIG. 1 is a skeleton diagram schematically illustrating an example of a vehicle on which a selectable one-way clutch is mounted. A vehicle Ve is a hybrid vehicle including an engine 1, a first motor MG1, and a second motor MG2 as power sources. The engine 1 is constituted by a well-known internal combustion engine. Each of the motors MG1 and MG2 is a known motor-generator having a motor function and an electric generation function and is electrically connected to a battery via an inverter (these are not illustrated).

A power train 100 of the vehicle Ve includes a power division mechanism 10, a transmission 20, a selectable one-way clutch (hereinafter, SOWC) 30, a counter gear mechanism 40, and a differential gear mechanism 50. In the vehicle Ve, power output from the engine 1 can be divided by the power division mechanism 10 to the side of the first motor MG1 and the side of driving wheels 2. When the SOWC 30 functions as a mechanism that bears an engine reaction force at the time of transmission of engine torque to the driving wheels 2, the transmission 20 functions as a speed increaser. The first motor MG1 is caused to function as an electricity generator with the mechanical power divided to the side of the first motor MG1, and the battery is charged with electric power generated by the first motor MG1 or the electricity is supplied to the second motor MG2 via the inverter. The electric power also enables the second motor MG2 to function as a motor.

Specifically, a crankshaft of the engine 1 is coupled to an input shaft 3. The input shaft 3 is positioned on the same axis as a rotation center axis of the crankshaft. In the power train 100, the power division mechanism 10, the first motor MG1, the transmission 20, and the SOWC 30 are positioned on the same axis as the input shaft 3. The second motor MG2 is positioned on a different axis from the rotation center axis of the engine 1.

The power division mechanism 10 includes a differential mechanism having a plurality of rotating elements and is constituted by a single-pinion planetary gear mechanism (a first planetary gear mechanism) in the example illustrated in FIG. 1. The power division mechanism 10 includes, as three rotating elements, a first sun gear S1 being an external gear, a first ring gear R1 being an internal gear placed concentrically with the first sun gear S1, and a first carrier C1 that holds a pinion gear meshing with the first sun gear S1 and the first ring gear R1 to be capable of rotating and revolving.

A rotor shaft 4 of the first motor MG1 is coupled to the first sun gear S1 so as to rotate together. The first carrier C1 is coupled to the input shaft 3 so as to rotate together and is coupled to the engine 1 via the input shaft 3. An output gear 5 of an external gear that transmits torque from the power division mechanism 10 to the driving wheels 2 is integrated with the first ring gear R1.

The output gear 5 meshes with a counter driven gear 42 and is coupled to the differential gear mechanism 50 via the counter gear mechanism 40 including the counter driven gear 42. The counter gear mechanism 40 includes a counter shaft 41 placed in parallel with the input shaft 3, the counter driven gear 42 meshing with the output gear 5, and a counter drive gear 43 meshing with a ring gear 51 of the differential gear mechanism 50. The counter driven gear 42 and the counter drive gear 43 are attached to the counter shaft 41 so as to rotate together. The driving wheels 2 are coupled to the differential gear mechanism 50 via right and left drive shafts 6, respectively.

The vehicle Ve is configured to enable torque output from the second motor MG2 to be added to the torque transmitted from the engine 1 to the driving wheels 2. The second motor MG2 includes a rotor shaft 7 that rotates with a rotor and the rotor shaft 7 is placed in parallel with the counter shaft 41. A reduction gear 8 meshing with the counter driven gear 42 is attached to the rotor shaft 7 so as to rotate together.

The transmission 20 includes a differential mechanism having a plurality of rotating elements and is constituted by a double-pinion planetary gear mechanism (a second planetary gear mechanism) in the example illustrated in FIG. 1. The transmission 20 includes, as three rotating elements, a second sun gear S2 being an external gear, a second ring gear R2 being an internal gear placed concentrically with the second sun gear S2, and a second carrier C2 that holds a first pinion gear and a second pinion gear to be capable of rotating and revolving. The first pinion gear meshes with the second sun gear S2. The second pinion gear meshes with the first pinion gear and the second ring gear R2.

The rotor shaft 4 of the first motor MG1 is coupled to the second sun gear S2 so as to rotate together. The input shaft 3 is coupled to the second carrier C2 so as to rotate together and the engine 1 is coupled to the second carrier C2 via the input shaft 3. That is, in the transmission 20 and the power division mechanism 10, the first sun gear S1 and the second sun gear S2 rotate together and the first carrier C1 and the second carrier C2 rotate together. A rotating-side member of the SOWC 30 is coupled to the second ring gear R2 of the transmission 20 via a coupling member 9. The second ring gear R2, the coupling member 9, and the rotating-side member of the SOWC 30 are configured to rotate together.

The SOWC 30 is configured to perform selective switching between an engagement state (a locked state) in which rotation directions of the second ring gear R2 are limited only to one direction and a release state (an unlocked state) in which the second ring gear R2 is enabled to rotate in the both directions. When the SOWC 30 is in the engagement state, the second ring gear R2 is restrained from rotating in the positive direction and the second ring gear R2 is allowed to rotate in the opposite direction. The positive direction is the same direction as a rotation direction of the crankshaft of the engine 1. The opposite direction is a direction opposite to the positive direction. The SOWC 30 is provided inside a transaxle case.

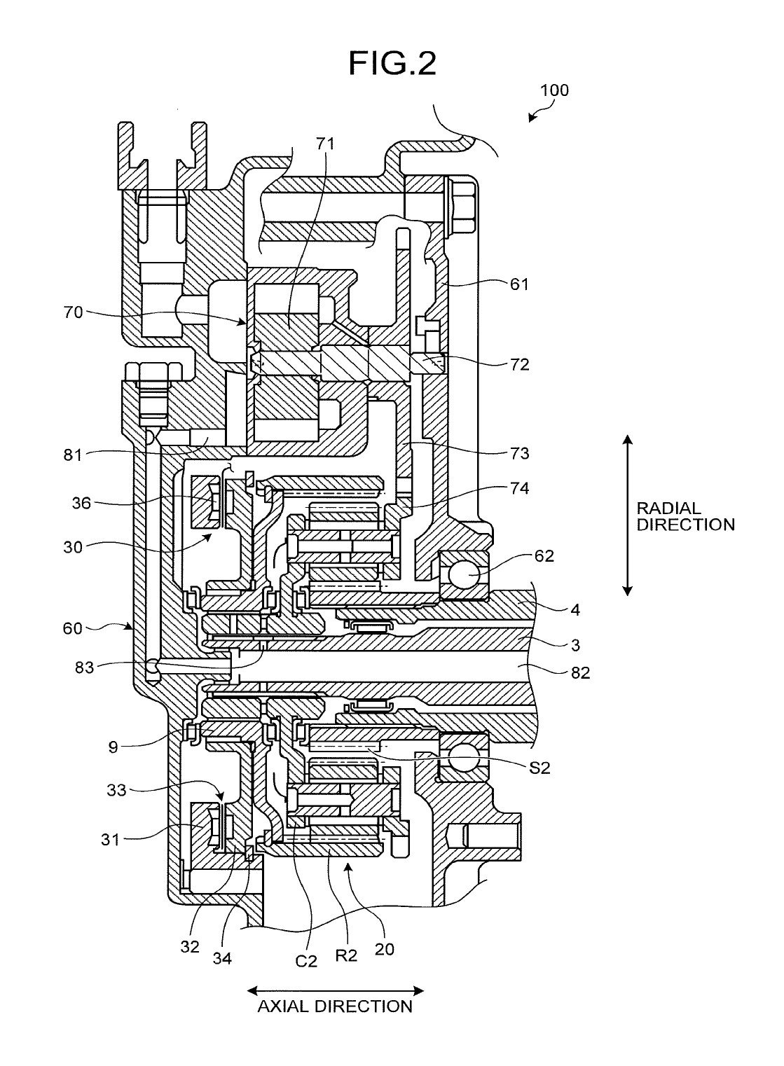

FIG. 2 is a sectional view illustrating the SOWC 30 in a transaxle case. In a transaxle case 60, the SOWC 30 is placed on the input shaft 3. The SOWC 30 includes a pocket plate 31 being a fixed-side member, a notch plate 32 being a rotating-side member, a selector plate 33 being a switching member, a snap ring 34, and struts 36 being engagement pieces held by the pocket plate 31.

In the SOWC 30, the plates 31, 32, and 33 are all formed in an annular shape and face with each other in an axial direction. The pocket plate 31 and the notch plate 32 are placed to face each other in the axial direction, and the selector plate 33 is placed between the pocket plate 31 and the notch plate 32.

In the transaxle case 60, a mechanical oil pump 70 that is driven by the engine 1 is provided. The oil pump 70 is provided at a position offset from the rotation center axis of the input shaft 3 and is coupled to the input shaft 3 via a transmission mechanism. The transmission mechanism includes a pump shaft 72 rotating with a pump rotor 71, a driven gear 73 attached to the pump shaft 72, and a pump drive gear 74 meshing with the driven gear 73. The driven gear 73 rotates with the pump rotor 71. The pump drive gear 74 rotates with the second carrier C2 of the transmission 20. The pump shaft 72 is supported by a support member 61 that is integrated with the transaxle case 60. A bearing 62 that supports the rotor shaft 4 of the first motor MG is attached to the support member 61.

Oil output from the oil pump 70 to a supply oil passage is supplied to lubrication requiring parts in the transaxle case 60, such as the power division mechanism 10 and the transmission 20. The lubrication requiring parts include a gear mechanism constituting the transaxle. The oil that lubricates the transaxle is supplied also to the SOWC 30. In the example illustrated in FIG. 2, a first oil passage 81 connected to an outlet of the oil pump 70 is communicated with a second oil passage 82 formed inside the input shaft 3 being a hollow shaft. The first oil passage 81 is formed in the transaxle case 60. The second oil passage 82 extends inside the input shaft 3 in the axial direction. A third oil passage 83 is formed in the input shaft 3 to radially pass through and the second oil passage 82 and the third oil passage 83 are communicated with each other. The oil output from the oil pump 70 is supplied to the transmission 20 and the SOWC 30 that are positioned on an outer circumferential side of the input shaft 3 via the first to third oil passages 81 to 83. In this case, the oil having flowed out of the third oil passage 83 is moved from a side of the input shaft 3 to a radially outer side due to a centrifugal force or a gravity force and is supplied to the SOWC 30. The oil is supplied to the SOWC 30 from an inner circumferential side of a portion in which the selector plate 33 and the notch plate 32 face each other.

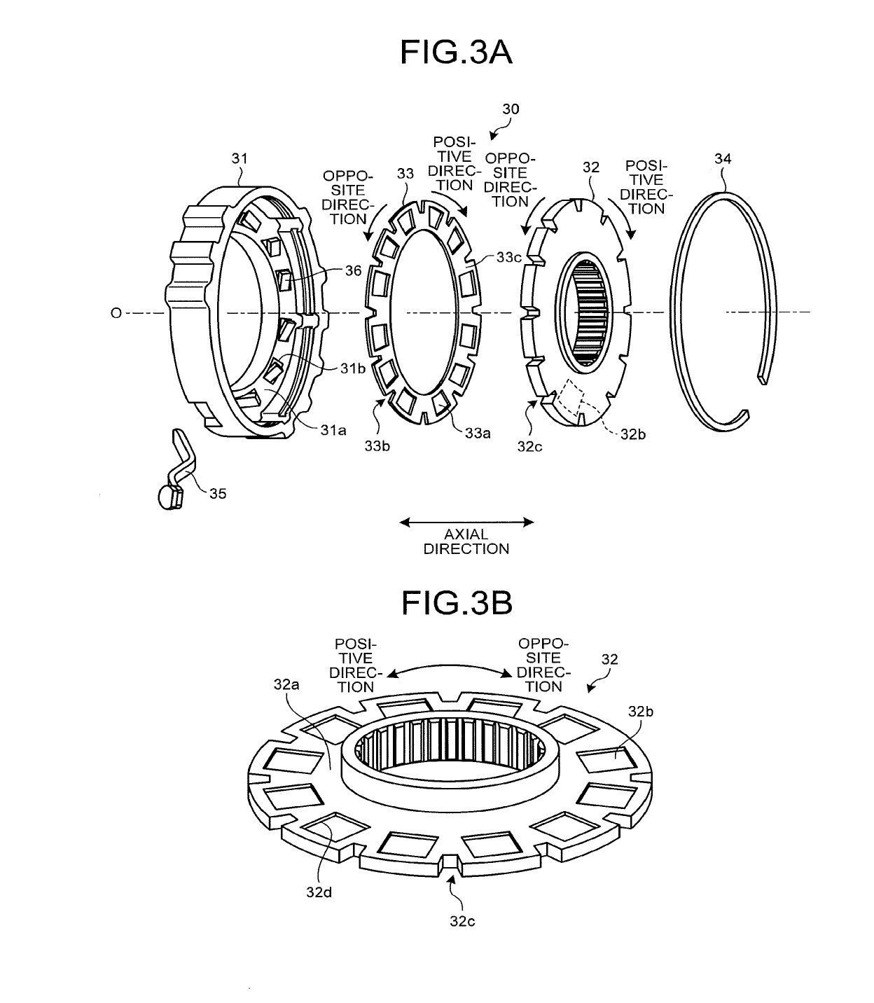

The SOWC 30 is described in detail with reference to FIG. 2 and FIGS. 3A to 3B. FIG. 3A is an exploded view of the SOWC 30. In FIG. 3A, a central axis of the SOWC 30 is illustrated by a dot-and-dash line O. FIG. 3B is a perspective view illustrating a facing surface of the notch plate 32 with respect to the selector plate 33 and that is not seen in FIG. 3A.

The pocket plate 31 is a fixed plate that is attached to the transaxle case 60 and that is fixed to be incapable of rotating. In the pocket plate 31, a plurality of concave pocket portions 31b are formed on a surface (a facing surface) 31a that faces the selector plate 33 in the axial direction. The pocket portions 31b are positioned at a predetermined circumferential interval. The struts 36 that engage with the notch plate 32 are attached to inner parts of the pocket portions 31b, respectively.

The notch plate 32 is a rotating plate configured to be capable of rotating relative to the pocket plate 31. As illustrated in FIG. 2, an inner circumferential portion of the notch plate 32 is spline-fitted to a hollow shaft portion of the coupling member 9 and the notch plate 32 and the second ring gear R2 rotate together. In the notch plate 32, as illustrated in FIGS. 3A and 3B, engagement concave portions 32b with which the struts 36 engage are formed on a surface (a facing surface) 32a that faces the pocket plate 31. The engagement concave portions 32b are provided at positions corresponding to the positions of the struts 36 provided in the pocket plate 31, that is, the pocket portions 31b, respectively. Accordingly, the engagement concave portions 32b are formed at a predetermined circumferential interval on the facing surface 32a of the notch plate 32.

On an outer periphery portion of the notch plate 32, a plurality of notch portions 32c in a shape passing therethrough in the thickness direction are formed. The notch portions 32c are formed in a shape obtained by notching (lightening) the notch plate 32 in the thickness direction from the facing surface 32a toward the opposite surface. The notch portions 32c are provided at a predetermined circumferential interval. In the SOWC 30, the notch portions 32c of the notch plate 32 are formed in a groove shape extending in the axial direction. An outer circumferential shape of the notch plate 32 is recessed and projected when viewed in the axial direction.

The selector plate 33 is a switching member that selectively switches the SOWC 30 between the release state and the engagement state. The selector plate 33 is configured to be capable of rotating relative to the pocket plate 31. A plurality of strut through-holes 33a are formed on the selector plate 33 at a predetermined circumferential interval. Plate portions that form portions between adjacent one of the through-holes 33a in the circumferential direction function as a structure for causing the struts 36 to retract toward the pocket plate 31. The through-holes 33a are formed at positions corresponding to the pocket portions 31b of the pocket plate 31. The selector plate 33 is configured to be moved (relatively rotated) circumferentially with respect to the pocket plate 31 by an actuator (not illustrated). Based on a circumferential position of the selector plate 33, a housed state in which the struts 36 are housed in the pocket portions 31b and a standing state in which the struts 36 engage with the engagement concave portions 32b are selectively switched. The selector plate 33 is coupled to the actuator via a selector arm 35.

On an outer periphery portion of the selector plate 33, a plurality of notch portions 33b in a shape passing therethrough in the thickness direction are formed. The notch portions 33b are formed in a shape obtained by notching (lightening) the selector plate 33 in the thickness direction from a surface (a facing surface) 33c that faces the notch plate 32 toward the opposite surface. The notch portions 33b are formed at a predetermined circumferential interval. In the SOWC 30, the notch portions 33b of the selector plate 33 are formed in a groove shape extending in the axial direction. An outer circumferential shape of the selector plate 33 is recessed and projected when viewed in the axial direction.

The snap ring 34 is fitted into an inner circumferential surface of a cylindrical portion of the pocket plate 31. In the SOWC 30, the snap ring 34 restrains axial movement of the notch plate 32 and the selector plate 33 to prevent the plates 32 and 33 from dropping out of the cylindrical portion of the pocket plate 31. As illustrated in FIG. 2, an outer circumferential portion of the selector plate 33 is supported by the inner circumferential surface of the cylindrical portion of the pocket plate 31. In the SOWC 30, the notch plate 32 and the selector plate 33 are configured in such a manner that provision of the notch portions 32c and 33b on the outer periphery portion of the notch plate 32 and the outer periphery portion of the selector plate 33 does not reduce outside diameters of the plates 32 and 33.

The selector arm 35 is a member that couples the actuator and the selector plate 33. The selector plate 33 is configured to be moved circumferentially in an engagement direction (rotated in the positive direction) with a force output from the actuator and transmitted to the selector plate 33 via the selector arm 35. The selector plate 33 is also configured to be moved circumferentially in a release direction (rotated in the opposite direction) by a return spring (not illustrated) provided in the actuator. The return spring has a bias force that causes the selector plate 33 to rotate in the opposite direction. The SOWC 30 is configured in such a manner that the selector plate 33 can be circumferentially reciprocated (relatively rotated) with the actuator within a predetermined angular range.

The struts 36 are plate-like engagement pieces and are members that engage with the engagement concave portions 32b to restrain the positive rotation of the notch plate 32. Ends of the struts 36 on the opposite direction side abut on wall surfaces (engagement concave surfaces) 32d of the engagement concave portions 32b on the opposite direction side, thereby restraining the positive rotation of the notch plate 32.

For example, ends of the struts 36 on the positive direction side are supported by support pins or the like in the pocket portions 31b. The struts 36 are configured to enable the ends on the opposite direction side to rock around the ends on the positive direction side as supports. Accordingly, the struts 36 can be brought to the standing state in which the ends on the opposite direction side stand and protrude toward outside of the pocket portions 31b, that is, a side nearer the notch plate 32 than the selector plate 33, and the housed state in which the ends on the opposite direction side are housed in the pocket portions 31b. A spring member (not illustrated) is provided between each of the struts 36 and a bottom portion of the corresponding pocket portion 31b. The spring member presses the strut 36 in the axial direction toward the notch plate 32. Due to an elastic force applied by the spring member, the end of the strut 36 on the opposite direction side can stand. On the other hand, a load of the selector plate 33 to house the struts 36 in the pocket portions 31b against the elastic force of the spring members, that is, an axial load acting from the selector plate 33 on the struts 36 enables the ends of the struts 36 on the opposite direction side to be retracted toward the pocket plate 31. Because the rotations of the notch plate 32 are not restrained in the state in which the struts 36 are housed in the pocket portions 31b, the notch plate 32 is enabled to rotate in both the positive direction and the opposite direction and the SOWC 30 is brought to the release state. In this case, in the power train 100, the second carrier C2 can rotate in both the positive direction and the opposite direction.

In the SOWC 30 thus configured, the notch portions 32c of the notch plate 32 are a structure for suppressing erroneous engagement of the SOWC 30 caused by the oil interposed between the notch plate 32 and the selector plate 33. That is, the notch portions 32c are a structure for reducing a shear stress of the oil occurring between the notch plate 32 and the selector plate 33 when the notch plate 32 rotates relative to the pocket plate 31. The shear stress occurring in the oil between the notch plate 32 and the selector plate 33 varies in the magnitude according to the oil viscosity, the oil flow rate, and the thickness of an oil layer, that is, the distance between the notch plate 32 and the selector plate 33. For example, the shear stress of oil can be represented by a basic equation {τ=μ·dU/dY} of a flow between two flat plates. In this equation, τ is the shear stress of the oil, μ is the viscosity of the oil, dU is a change amount of the oil flow rate, and dY is a change amount of the thickness of an oil layer formed between the two flat plates. First, as for the oil viscosity μ, the shear stress of the oil occurring between the plates 32 and 33 is higher in a case where the oil viscosity is high than in a case where the oil viscosity is low. The oil viscosity changes according to a change in the temperature of the oil, and generally the oil viscosity is higher in a case where the oil temperature is low than in a case where the oil temperature is high. Therefore, in the case where the oil temperature is low, the shear stress of the oil occurring between the plates 32 and 33 is higher than in the case where the oil temperature is high. Next, as for the change amount dU of the oil flow rate, the shear stress of the oil between the plates 32 and 33 is higher in a case where the oil flow rate between the plates 32 and 33 is high than in a case where the oil flow rate is low. Because the flow of the oil in the SOWC 30 is produced by the rotations of the notch plate 32, a direction in which the oil flows is a circumferential direction (a rotation direction). Accordingly, the oil flow rate is increased from the rotation center to a radially outer side. That is, the oil flow rate on an outside diameter side of the notch plate 32 is higher than the flow rate on an inside diameter side of the notch plate 32. As for the change amount dY of the thickness of the oil layer, the shear stress of the oil occurring between the plates 32 and 33 is higher in a case where the thickness of the oil layer is small than in a case where the oil layer thickness is large. That is, in a case where the distance between the notch plate 32 and the selector plate 33 is small, the shear stress of the oil between the plates 32 and 33 is higher than in a case where the distance between the notch plate 32 and the selector plate 33 is large. In the present embodiment, provision of the notch portions 32c on the outer periphery portion of the notch plate 32 can increase the thickness of the oil layer at a radially outer portion in which the oil flow rate is relatively high. Therefore, the magnitude of the shear stress of the oil can be effectively reduced.

Furthermore, similarly to the notch portions 32c of the notch plate 32, the notch portions 33b of the selector plate 33 are a structure for suppressing erroneous engagement of the SOWC 30 caused by the oil interposed between the notch plate 32 and the selector plate 33. That is, the notch portions 33b are a structure for reducing the shear stress of the oil occurring between the notch plate 32 and the selector plate 33 when the notch plate 32 rotates relative to the pocket plate 31. Therefore, provision of the notch portions 33b on the outer periphery portion of the selector plate 33 can increase the thickness of the oil layer at a radially outer portion in which the oil flow rate is relatively high and accordingly the magnitude of the shear stress of the oil can be effectively reduced.

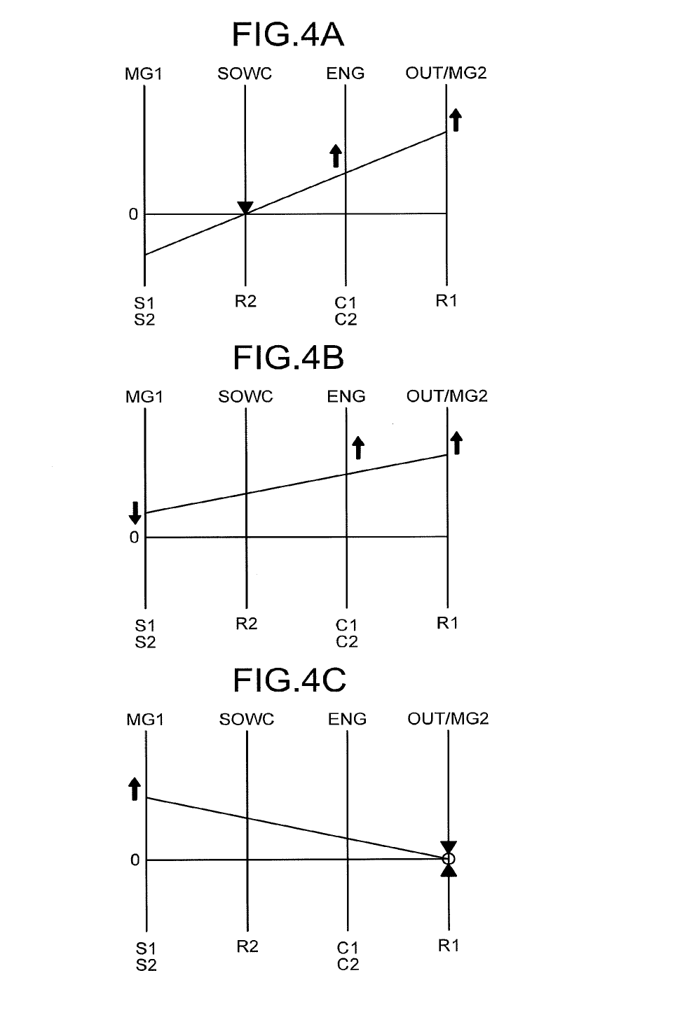

Driving modes of the vehicle Ve having the SOWC 30 mounted thereon are described next with reference to FIGS. 4A to 4C. In this example, a driving mode (OD mode) that can be set by bringing the SOWC 30 to the engagement state, a driving mode (THS mode) that can be set by bringing the SOWC 30 to the release state, and an engine start time are described. FIG. 4A is a collinear diagram illustrating a vehicle state in a case where a vehicle is driven forward in the OD mode. FIG. 4B is a collinear diagram illustrating a vehicle state in a case where a vehicle is driven forward in the THS mode. FIG. 4C is a collinear diagram illustrating a vehicle state at the time of an engine start. The hybrid vehicle Ve can be set in various modes.

In the OD mode, the SOWC 30 is brought to the engagement state, so that the transmission 20 functions as a speed increaser. When the driving mode is to be transitioned to the OD mode from other modes, an electronic control unit (ECU) (not illustrated) outputs an instruction signal to the actuator of the SOWC 30 to move the selector plate 33 to a position in which the struts 36 can engage with the engagement concave portions 32b, respectively. At that time, the actuator rotates the selector plate 33 in the positive direction to circumferentially align the through-holes 33a with the pocket portions 31b, thereby opening the pocket portions 31b. This causes the ends on the opposite direction side of the struts 36 pressed by the spring members to protrude from the opened pocket portions 31b toward the notch plate 32 and to abut on the engagement concave surfaces 32d on the opposite direction side of the engagement concave portions 32b. As a result, the state in which the positive rotation of the notch plate 32 is restrained is achieved.

As illustrated in FIG. 4A, because the positive rotation of the second carrier C2 is restrained by the SOWC 30 in the OD mode, the SOWC 30 functions as a reaction force receiver for engine torque. In the OD mode, the engine reaction force can be received by the SOWC 30 being a mechanical structure, without consumption of power by the first motor MG1 to bear the engine reaction force. The number of rotations of the first carrier C1 being an input element is lower than the number of rotations of the first ring gear R1 being an output element, and rotations input by the engine 1 are increased for speed-up to be output from the output gear 5. That is, an overdrive state is achieved.

As illustrated in FIG. 4B, the THS mode is a mode in which the SOWC 30 is brought to the release state and the reaction force for the power of the engine 1 is produced by the first motor MG1 to drive the vehicle. While the vehicle Ve is being driven forward in the THS mode, the engine 1 outputs torque and the first motor MG1 outputs motor torque in the opposite direction to the engine torque. Accordingly, the first motor MG1 functions as a reaction force receiver for the engine torque and outputs the engine torque from the power division mechanism 10 toward the driving wheels 2. Positive torque is torque acting in the same direction as the engine torque. Opposite toque is torque acting in the opposite direction to the engine torque.

As illustrated in FIG. 4C, at the time of an engine start, the SOWC 30 is brought to the release state and the number of engine rotations is increased by the first motor MG1. During parking of the vehicle, a shift lever is positioned in a parking range to lock the drive shaft 6 to be incapable of rotating. Accordingly, when the first motor MG1 outputs positive torque to increase the number of motor rotations in the positive direction, the second ring gear R2 rotates in the positive direction to increase the number of rotations of the engine 1 because the first ring gear R1 is incapable of rotating. The release state of the SOWC 30 enables motoring by the first motor MG1. That is, if the SOWC 30 is erroneously engaged at the time of an engine start, the second ring gear R2 is prevented from positively rotating, which prevents the crankshaft from rotating. Particularly while the engine 1 is stopped, the oil temperature is low and thus the oil viscosity becomes high. Even in such an oil state at a low temperature and with a high viscosity, the SOWC 30 of the present embodiment can effectively reduce the shear stress of the oil when the engine 1 is started in the state at a low oil temperature (at the time of a cold start) because the notch portions 32c and 33b are provided on the outer periphery portions of the plates 32 and 33. Therefore, at the time of an engine start, erroneous engagement of the SOWC 30 can be suppressed and thus occurrence of an engine stall due to an unintended lock of the rotation shaft can be suppressed.

As described above, according to the selectable one-way clutch of the present embodiment, notch portions are provided on an outer periphery portion of a selector plate and an outer periphery portion of a notch plate. Therefore, the shear stress occurring in oil between the notch plate and the selector plate can be reduced. This enables suppression of drawing of the selector plate to be erroneously rotated in the engagement direction when the notch plate is relatively rotated. That is, erroneous engagement of the selectable one-way clutch can be suppressed.

Furthermore, a small constitution of the selectable one-way clutch with a short shaft length is realized by placing the plates to face each other. According to the present embodiment, erroneous engagement can be suppressed in a small selectable one-way clutch. For example, if a return spring is strengthened so as not to erroneously move the selector plate in the engagement direction, an actuator that can output a force against the return spring at the time of engagement needs to be provided. However, the size of the actuator is enlarged, the mountability is lowered, and the cost is increased. It is alternatively conceivable that the plates are placed to increase the distance between the plates so as to reduce the shear stress of the oil. However, the shaft length of the selectable one-way clutch is increased and the constitution is enlarged. In the present embodiment, a structure that can suppress erroneous engagement in a small selectable one-way clutch can be realized without contradictions described above.

The present disclosure is not limited to the above embodiment and can be modified as appropriate without departing from the scope of the invention.

The embodiment described above is a configuration example in which the notch portions are provided on the outer periphery portions of both the notch plate and the selector plate. However, the present disclosure includes a configuration in which the notch portions are provided only on the outer periphery portion of at least one of the notch plate and the selector plate. For example, in a configuration in which the notch portions are provided only on the outer periphery portion of the notch plate out of the two plates, an outer circumferential shape of the selector plate without the notch portions is circular. Alternatively, in a configuration in which the notch portions are provided only on the outer periphery portion of the selector plate out of the two plates, an outer circumferential shape of the notch plate without the notch portions is circular. The point is that a configuration in which the notch portions are provided on the outer periphery portion of one of the two plates can eliminate the need to change placement of the rotating plate and the selector plate to increase the distance between the plates so as to reduce the shear stress of oil interposed between the plates. That is, when the rotating plate is rotated relative to the selector plate in a state where lubricating oil is interposed between the rotating plate and the selector plate, the shear stress occurring in the oil can be reduced similarly in a structure with an increased distance between two flat plates between which the oil is interposed. This configuration provides a small structure and enables suppression of an erroneous rotation of the selector plate in the engagement direction due to being drawn by the oil, which can suppress the selectable one-way clutch from being erroneously engaged.

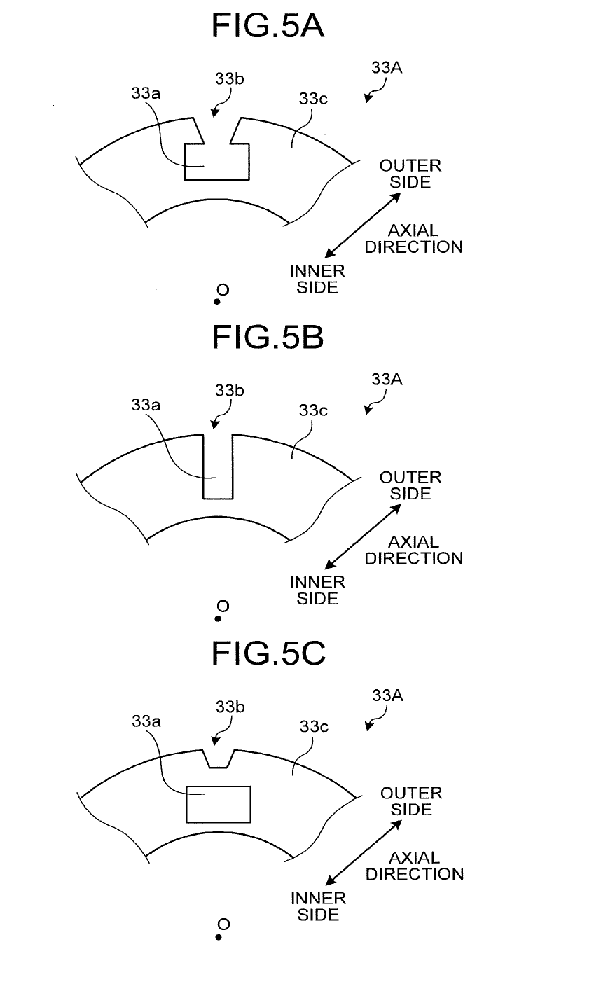

The notch portions of the present disclosure are provided on the radially outer periphery portion of an annular plate and circumferential positions thereof are not particularly limited. For example, the embodiment described above is a configuration example in which the notch portions 33b and the through-holes 33a are in different phases (at circumferentially different positions) in the selector plate. However, a modification thereof is a structure in which the notch portions 33b and the through-holes 33a are provided in the same phase (at the circumferentially same positions). FIGS. 5A to 5C are schematic diagrams illustrating modifications. As illustrated in FIG. 5A, the notch portions 33b are provided in the same phase as that of the through-holes 33a on an outer periphery portion of a selector plate 33A as a modification. In a case where the notch portions 33b and the through-holes 33a are in the same phase, the circumferential width of the notch portions 33b can be similar to that of the through-holes 33a. For example, the selector plate 33A in which the through-holes 33a are formed in a shape connecting to the notch portions 33b to extend to an outside diameter side as illustrated in FIG. 5B can be alternatively used. That is, the selector plate 33A has a structure in which the through-holes 33a are notched to an outside diameter side. Alternatively, the selector plate 33A formed in such a manner that the notch portions 33b and the through-holes 33a are not connected as illustrated in FIG. 50 can be used.

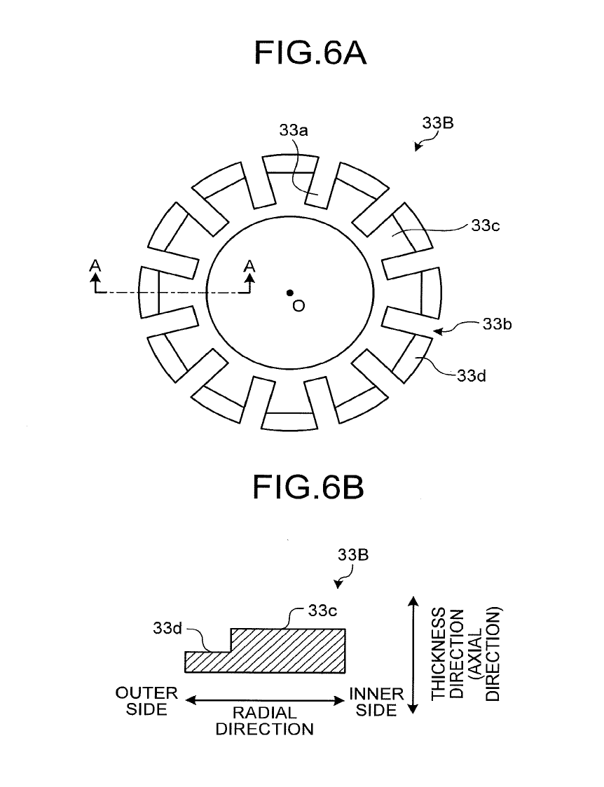

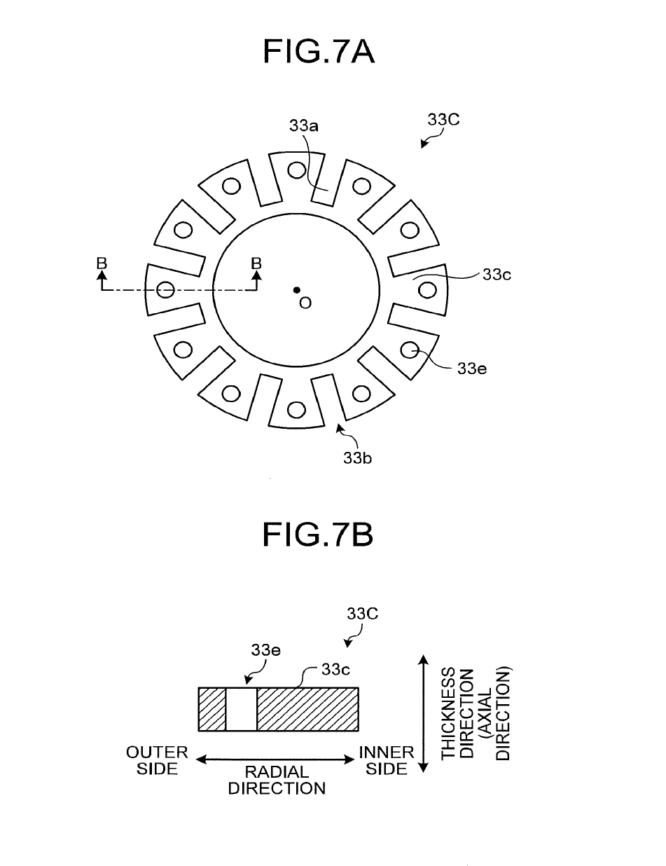

A further modification of the modification in which the notch portions and the through-holes are in the same phase as illustrated in FIGS. 5A to 5C is a structure in which second notch portions that form concave portions are provided on a selector plate in a different phase from that of the through-holes. FIGS. 6A and 6B are schematic diagrams illustrating an example of the modification. FIGS. 7A and 7B are schematic diagrams illustrating another example of the modification. As illustrated in FIG. 6A, on an outer periphery portion of the selector plate 33B, second notch portions 33d that form groove portions extending circumferentially along the outer periphery portion are provided in addition to the notch portions 33b. As illustrated in FIG. 6B, the second notch portions 33d are concave portions formed in a shape thinned from the facing surface 33c and are formed to be relatively thinner than the radially inner side of the facing surface 33c. When the facing surface 33c of the selector plate 33B is viewed in the axial direction, the second notch portions 33d are formed to extend in the circumferential direction to connect circumferentially adjacent notch portions 33b and 33b with each other. As illustrated in FIG. 7A, in a selector plate 33C, third notch portions 33e are provided on a radially inner side than the outer periphery portion in addition to the notch portions 33b on the outer periphery portion. The third notch portions 33e are through-holes and are provided at positions not connecting to the notch portions 33b. The third notch portions 33e are not limited to the through-holes and can be concave portions (holes) recessed from the facing surface 33c toward the opposite surface.

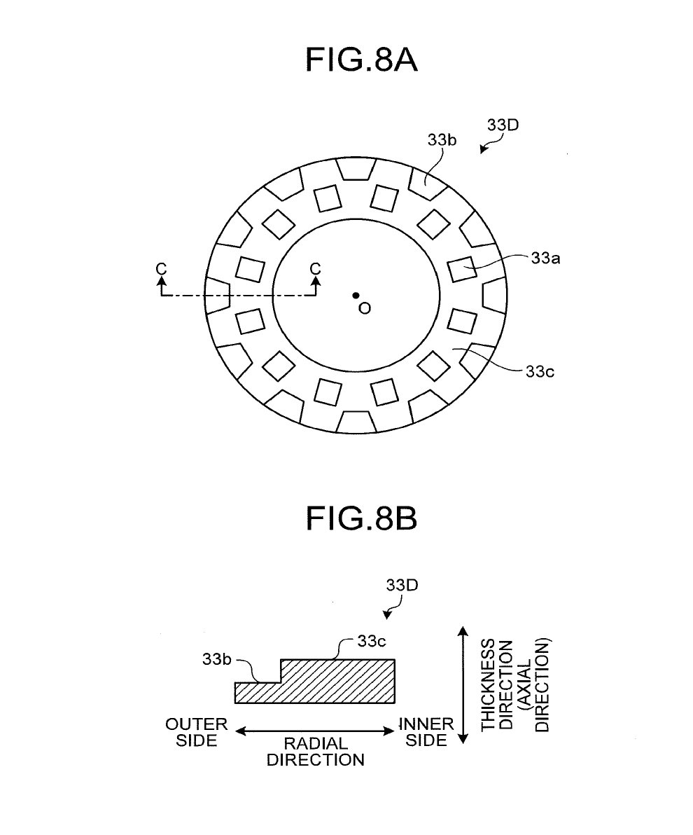

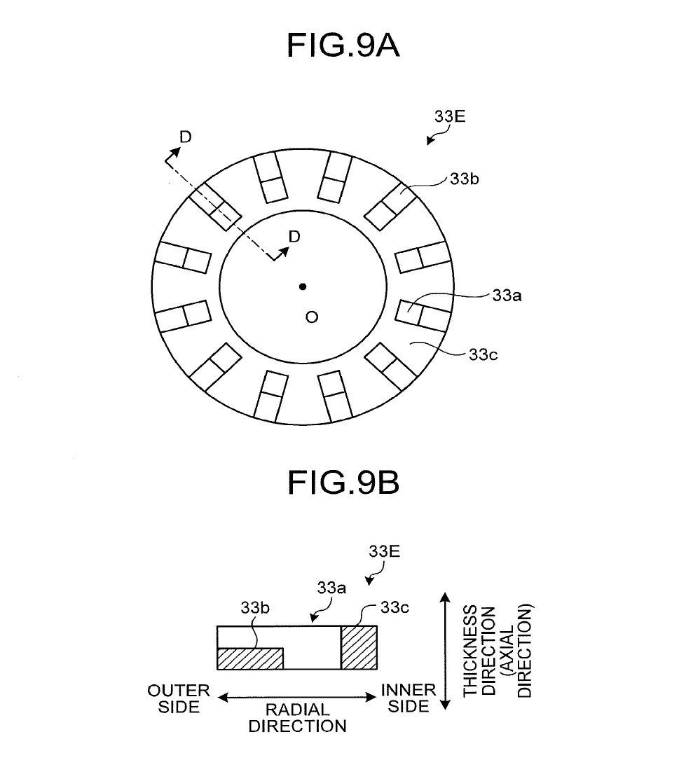

The notch portions 33b in the configuration examples described above have a shape passing through the selector plate 33 in the thickness direction (a structure obtained by lightening the plate in the entire plate thickness). However, a modification thereof can be a structure in which the selector plate 33 is thinned. FIGS. 8A to 9B illustrate configuration examples of the modification. FIG. 8A is a schematic diagram illustrating a selector plate 33D of a modification in which the notch portions 33b illustrated in FIG. 3A are concave portions obtained by thinning the plate so as to leave a part of the plate thickness. In the selector plate 33D, the notch portions 33b and the through-holes 33a are positioned in different phases. As illustrated in FIG. 8B, the notch portions 33b of the selector plate 33D are formed as concave portions by lightening the plate so as to form a part of the facing surface 33c. FIG. 9A is a schematic diagram illustrating a selector plate 33E of a modification in which the notch portions 33b illustrated in FIG. 5B are concave portions formed by thinning the plate so as to leave a part of the plate thickness. In the selector plate 33E, the notch portions 33b and the through-holes 33a are positioned in the same phase. As illustrated in FIG. 9B, the notch portions 33b of the selector plate 33E are concave portions obtained by thinning the plate so as to form a part of the facing surface 33c, and form the facing surface 33c on an radially outer side of the through-holes 33a. As another modification, the notch portions 33b illustrated in FIGS. 9 can be applied to the configuration examples illustrated in FIGS. 6 and 7 described above.

While the modifications described above with reference to FIGS. 5A to 9 are those for the selector plate 33, the structures of the modifications can be applied as a structure of the notch portions provided on the outer periphery portion of the notch plate 32. When the modifications are thus applied to the notch plate 32, the through-holes 33a in the descriptions of the above modifications are read as the engagement concave portions 32b. In this case, because the engagement concave portions 32b are concave portions, a structure different from those in the above modifications is that the engagement concave portions 32b form a part of the facing surface 32a.

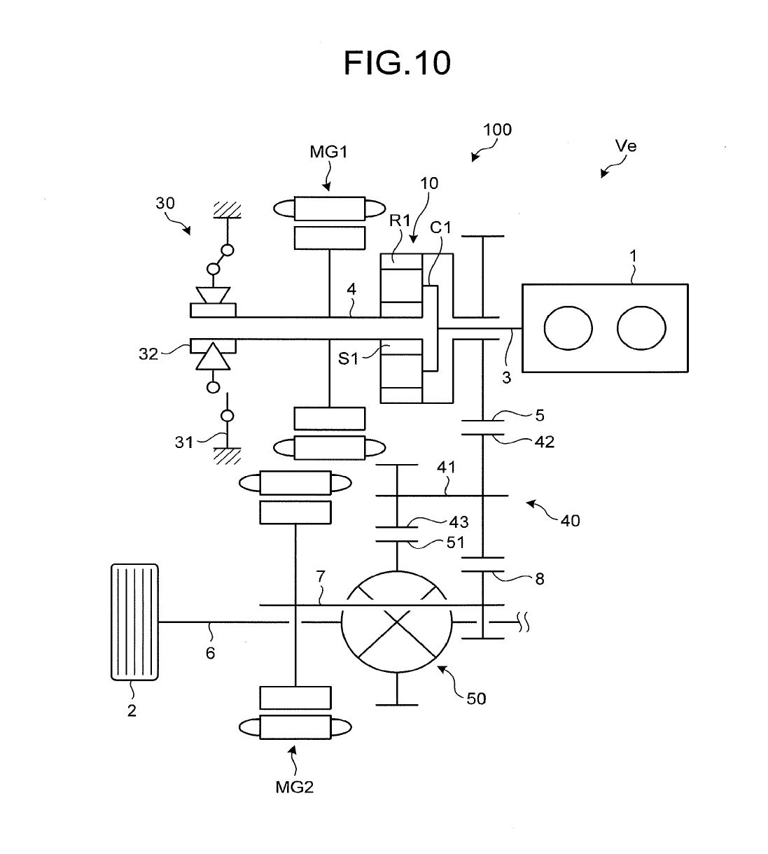

The vehicle on which the SOWC 30 is mounted is not limited to the vehicle Ve described above with reference to FIG. 1. FIG. 10 is a skeleton diagram illustrating an example of a modification of the vehicle Ve. On the vehicle Ve illustrated in FIG. 10, the transmission 20 is not mounted unlike the vehicle Ve described above and illustrated in FIG. 1. In the power train 100 illustrated in FIG. 10, the notch plate 32 of the SOWC 30 is coupled to the first sun gear S1 of the power division mechanism 10 to rotate together. The SOWC 30 is configured to selectively switch the first sun gear S1 of the power division mechanism 10 between the engagement state and the release state. For example, when the SOWC 30 is brought to the engagement state and the vehicle Ve is driven forward with the power of the engine 1, the positive rotation of the first sun gear S1 is restrained and thus the power division mechanism 10 functions as a speed increaser. Furthermore, at the time of an engine start, the SOWC 30 is brought to the release state to enable the first motor MG1 to output positive torque and to positively rotate, so that the engine 1 can be motored by the first motor MG1.

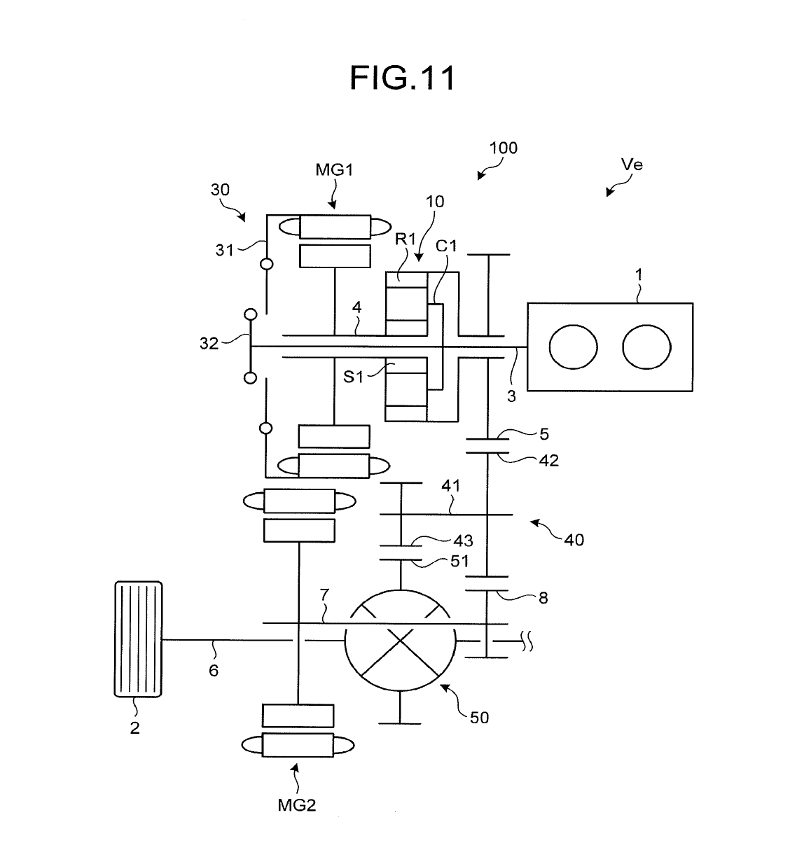

FIG. 11 is a skeleton diagram illustrating another modification of the vehicle Ve. The vehicle Ve illustrated in FIG. 11 does not have the transmission 20 mounted thereon unlike the vehicle Ve described above and illustrated in FIG. 1. In the power train 100 illustrated in FIG. 11, the notch plate 32 of the SOWC 30 is coupled to the first carrier C1 of the power division mechanism 10 to rotate together. The SOWC 30 is configured to selectively switch the first carrier C1 of the power division mechanism 10 between the engagement state and the release state. That is, when the SOWC 30 is brought to the engagement state, the crankshaft of the engine 1 becomes incapable of rotating. Accordingly, when the SOWC 30 is brought to the engagement state and motor torque of the second motor MG2 is transmitted to the driving wheels 2 in an EV drive mode, the SOWC 30 bears the reaction force. When the SOWC 30 is brought to the release state, the engine 1 can be motored by the first motor MG1 and the vehicle Ve can be driven forward with the power output from the engine 1.

In an embodiment described above, the notch portions are formed on the outer periphery portion of at least one of the rotating plate and the selector plate to pass through the plate in the thickness direction. Therefore, when the rotating plate rotates relative to the selector plate in a state where lubricating oil is interposed between the rotating plate and the selector plate, the shear stress occurring in the oil can be reduced without a change in placement of the rotating plate and the selector plate to increase the distance between the plates, similarly in a structure with an increased distance between two flat plates between which oil is interposed. Accordingly, an erroneous rotation of the selector plate in the engagement direction due to being drawn by the oil can be suppressed and thus erroneous engagement of the selectable one-way clutch can be suppressed. Because there is no need to change the placement of the rotating plate and the selector plate so as to increase the distance therebetween to in order to reduce the shear stress of the oil interposed between the plates, an increase in the size of the selectable one-way clutch can be avoided.

Furthermore, the shear stress of the oil can be effectively reduced on a radially outer side where the flow rate of the oil is increased at the time of the relative rotation of the rotating plate because the notch portions are formed on the outer periphery portion of the plate. Further, the notch portions pass through the plate in the thickness direction and this corresponds to lightening of the plate in the entire thickness direction. Therefore, the plate becomes more lightweight and a more lightweight selectable one-way clutch can be provided.

In an embodiment described above, the notch portions formed on the outer periphery portion of at least one of the rotating plate and the selector plate are the concave portions obtained by lightening the facing surface between the selector plate and the rotating plate in the thickness direction. That is, as for the distance between the rotating plate and the selector plate facing each other, the distance between the facing surfaces is larger at positions where at least one of the facing surfaces is formed to include the concave portions than at positions where portions that are not the concave portions face each other. Accordingly, when the rotating plate rotates relative to the selector plate in a state where lubricating oil is interposed between the rotating plate and the selector plate, the shear stress occurring in the oil can be reduced similarly in the structure with an increased distance between two flat plates between which oil is interposed. This enables suppression of an erroneous rotation of the selector plate in the engagement direction due to being drawn by the oil and thus enables suppression of erroneous engagement of the selectable one-way clutch. Additionally, because there is no need to change placement of the rotating plate and the selector plate so as to increase the distance between the plates to in order to reduce the shear stress of the oil interposed between the plates, an increase in the size of the selectable one-way clutch can be avoided. The notch portions are formed on the outer periphery portion of the plate and therefore the shear stress of the oil can be effectively reduced on a radially outer side where the flow rate of the oil is increased at the time of a relative rotation of the rotating plate. Furthermore, because the notch portions correspond to lightening of the plate, the plate becomes more lightweight and a more lightweight selectable one-way clutch can be provided.

According to the present disclosure, notch portions are formed on an outer periphery portion of at least one of a rotating plate and a selector plate by lightening the plate in the thickness direction. Therefore, when the rotating plate rotates relative to the selector plate in a state where lubricating oil is interposed between the rotating plate and the selector plate, a shear stress occurring in the oil can be reduced without a change in placement of the rotating plate and the selector plate to increase the distance between the plates, similarly in a structure with an increased distance between two flat plates between which oil is interposed. Accordingly, an erroneous rotation of the selector plate in an engagement direction due to being drawn by the oil can be suppressed and erroneous engagement of a selectable one-way clutch can be suppressed. Additionally, there is no need to change the placement of the rotating plate and the selector plate so as to increase the distance between the plates to in order to reduce the shear stress of the oil interposed between the plates and thus an increase in the size of the selectable one-way clutch can be avoided. Because the notch portions are formed on the outer periphery portion of the plate, the shear stress in the oil can be effectively reduced on a radially outer side where the flow rate of the oil is increased at the time of a relative rotation of the rotating plate. Furthermore, because the notch portions correspond to lightening of the plate, the plate becomes more lightweight and thus a more lightweight selectable one-way clutch can be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A selectable one-way clutch comprising:
a fixed plate;
an annular rotating plate that is placed to face the fixed plate and rotates relative to the fixed plate;
an engagement piece that is held by the fixed plate to protrude from the fixed plate toward the rotating plate;
an engagement concave portion that is formed on the rotating plate to be engaged with the engagement piece protruding from the fixed plate toward the rotating plate; and
an annular selector plate that is placed between the fixed plate and the rotating plate and switches between a state in which the engagement piece is protruded toward the rotating plate and a state in which the engagement piece is retracted toward the fixed plate not to be in contact with the rotating plate,
the selectable one-way clutch being configured to selectively switch between an engagement state in which the engagement piece engages with the engagement concave portion to limit rotations of the rotating plate to one direction and a release state in which rotations of the rotating plate in both directions are allowed, wherein notch portions are formed on an outer periphery portion of at least one of the selector plate and the rotating plate to have a shape passing through the plate in a thickness direction.

2. A selectable one-way clutch comprising:
a fixed plate;
an annular rotating plate that is placed to face the fixed plate and rotates relative to the fixed plate;
an engagement piece that is held by the fixed plate to protrude from the fixed plate toward the rotating plate;
an engagement concave portion that is formed on the rotating plate to be engaged with the engagement piece protruding from the fixed plate toward the rotating plate; and
an annular selector plate that is placed between the fixed plate and the rotating plate and switches between a state in which the engagement piece is protruded toward the rotating plate and a state in which the engagement piece is retracted toward the fixed plate not to be in contact with the rotating plate,
the selectable one-way clutch being configured to selectively switch between an engagement state in which the engagement piece engages with the engagement concave portion to limit rotations of the rotating plate to one direction and a release state in which rotations of the rotating plate in both directions are allowed, wherein
notch portions are formed on an outer periphery portion of at least one of the selector plate and the rotating plate, and
the notch portions are concave portions obtained by lightening a facing surface between the selector plate and the rotating plate in a thickness direction.
